(19) United States
(12) Patent Application Publication
(10) Pub. No.: US 2006/0242426 A1
(43) Pub. Date: Oct. 26, 2006

(54) Configuring a network connection

(76) Inventors: Oliver Schreyer, Herzogenrath (DE); Wolfgang Otto budde, (US); Bozena Erdmann, (US); Armand Lelkens, (US)

Correspondence Address: PHILIPS INTELLECTUAL PROPERTY & STANDARDS, P.O. BOX 3001, BRIARCLIFF MANOR, NY, 10510, US

(21) Appl. No.: 10/566,511

(22) PCT Filed: Jul. 20, 2004
(86) PCT No.: PCT/IB04/51260

§ 371 Date: Jan. 30, 2006

(30) Foreign Application Priority Data
Aug. 1, 2003 (EP) 03102410.2

(51) Int. Cl. H04K 1/00

(52) U.S. Cl. 713/186

(57) ABSTRACT

The invention relates to a method of accommodating a network apparatus (2) in an existing network (A), wherein a user (1) supplies characteristic biometrical data to the apparatus (2) as well as to the apparatuses of the network (A) via a biometry module. A network identifier and/or a configuration key can then be derived from the biometrical data. The network identifier can ensure that the new apparatus (2) is correctly assigned to the desired network (A), also when there are still other networks (B) within its range. The configuration key can be used for securing the information exchanged during the configuration phase from interception.

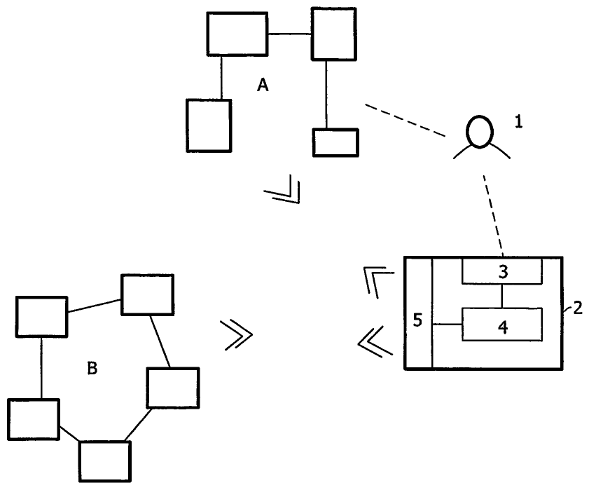

The invention relates to a network apparatus, a method of assigning such an apparatus to a network and a method of configuring a communication connection between such an apparatus and a network.

When introducing a new network apparatus into an existing wireless network, there is the problem that the new apparatus establishes a radio-technical connection with a plurality of different networks because of the generally undirected, broadly scattered wireless communication, and must correctly select the desired network from these networks. For example, a portable computer which is to be connected to a wireless home network may also be within the range of the network of a neighboring dwelling so that a selection of the correct assignment is required when establishing the communication connection. It is known that all apparatuses of a network can be identified by a joint identification, referred to as network identifier. Usually, this network identifier is not yet known to a new apparatus to be introduced and should therefore first be supplied in a cumbersome manner. Similar problems also occur in wired networks in which the cable system used for communication is open to different users, for example, in bus systems and particularly when using the power line for data communication.

Furthermore, it is necessary in wireless or open wired networks to secure the communication among the apparatuses against unauthorized listening or interception. To this end, it is required that all apparatuses of the network have a shared key, i.e. secret information which is known to these apparatuses only. When introducing a new apparatus into a network, there is again the problem of the way in which the new apparatus can secure said key.

A wireless network apparatus is known from JP-2001 186123 A, in which a personal identification number (PIN) is derived from the user's fingerprint by means of a sensor and with which the overall data exchange with other apparatuses of a network is encrypted.

It is an object of the present invention to provide means for configuring a new network connection with which particularly a user-friendly, correct assignment of the new apparatus as well as preferably also secure data traffic is possible.

This object is solved by a network apparatus having the characterizing features defined in claim 1 and by a method having the characterizing features defined in claims 6 and 7. Advantageous embodiments are defined in the dependent claims.

The network apparatus according to the invention, which may be, for example, a portable computer, a video camera, an audio apparatus, a TV apparatus, a mobile phone or the like, comprises the following components:
a biometry module for detecting biometrical data of a user. Such biometry modules are known in different embodiments for detecting different biometrical characteristics (fingerprint, voice, DNA, etc.) and are characterized in that they can determine data which are characteristic of a human user.
a configuration module which is coupled to the biometry module and is adapted to determine an unambiguous network identifier and/or an unambiguous initial key from a user's biometrical data provided by the biometry module for the encrypted communication (particularly in the configuration phase) with a second apparatus. The second apparatus is preferably also of the type of the network apparatus according to the invention, i.e. it is equipped with a biometry module and a configuration module.

The network apparatus described may use biometrical data of a user for the purpose of identifying all apparatuses belonging to a given network (network identifier). In this case it is not strictly necessary to keep the network identifier secret. It may therefore be openly supplied or supplied in an encrypted form, from one apparatus to another in order that both apparatuses can decide whether they belong or do not belong to the same network. A comfortable management of a home network is particularly possible by deriving a network identifier from biometrical data of a user. In fact, such a home network is usually characterized in that (only) a given user has access to all associated apparatuses of the network. He can thus particularly supply his biometrical data, for example, a fingerprint to all apparatuses so that these apparatuses can derive a network identifier therefrom. When a new apparatus is to be connected to the existing network, the user only needs to provide also this apparatus with his biometrical data from which the configuration module of the apparatus determines the network identifier. The apparatus is thus subsequently capable of connecting to the “right” home network of the user, namely also when it might be radio-technically situated within the range of other networks.

Additionally or alternatively, the configuration module can also determine an “initial key” from the biometrical data of the user, with which key a secure (i.e. encrypted) communication between apparatuses of the home network is guaranteed from the start. Unauthorized interception of the communication during the configuration is therefore harmless because the unauthorized listener cannot decrypt the exchanged information. Here again, it is an advantage that the configuration key can be provided to the apparatuses of a home network in a very simple manner without the user requiring technical knowledge or having to perform complicated input procedures.

Furthermore, the network apparatus is preferably adapted to eliminate the biometrical data of a user, detected by the biometry module, after their use by the configuration module. Only the derived network identifiers or keys are stored. In this way, it is ensured that the biometrical data are not stored any longer than is necessary for the envisaged object. Abuse of these data is therefore excluded when the associated apparatuses come in the possession of third parties, for example, when they are sold.

In accordance with a further embodiment of the invention, the configuration module is adapted to manage a list of biometrical data and/or data derived therefrom (for example, network identifiers) so as to enable, for example, a plurality of users to configure the network and its components. In this way, it is possible to enable a plurality of users to configure the network and its components in a parallel way. For example, a new apparatus can be connected to the network when it is provided with the biometrical data of one of the users from the user group so that the network identifier derived therefrom is comprised in said list.

As already stated, the communication between the apparatus and the second apparatus can take place in a wireless or wired way, wherein a wired communication can particularly take place via a power supply mains.

The invention further relates to a method of assigning a network apparatus to a given network, for example, logging a portable computer into one of a plurality of home networks situated within the radio range. In the method, biometrical data of a user are detected by the apparatus as well as by the network, and the network identifier is derived from the data. The apparatuses belonging to a given network are thus characterized in that a given user provides all of these apparatuses with his biometrical data for reading and deriving an unambiguous network identifier. The method is therefore particularly suitable for solving the assignment problem in home networks in which, typically, a user has access to all components.

The invention also relates to a method of configuring a communication connection between a network apparatus and a network. Again, biometrical data of a user are detected by the apparatus as well as by the network, and a key for a secure communication during the configuration is generated from the detected data. This method is also particularly suitable for home networks where it provides the possibility of a configuration free from interception. The user does not require any detailed technical knowledge for this purpose but, in contrast, the required procedure necessitating only a touch of the new apparatus belonging to the network is even plausible for laymen.

The invention will hereinafter be elucidated, by way of example, with reference to the accompanying drawing. The sole FIGURE shows diagrammatically a network apparatus according to the invention during configuration of a communication connection with a home network.

The references A and B in the FIGURE denote two different home networks in which apparatuses such as, for example, video recorders, TV apparatuses, stereo equipment, computers etc. belonging to a given household are coupled together in a wireless or wired manner. A wired connection is particularly a so-called power line connection with which the data communication takes place via the power supply mains.

In the basic situation, the two networks A, B should have an overlapping radio range, for example, because they are arranged in neighboring dwellings (such an overlap would also be obtained in a power line communication). The overlapping ranges lead to a problem when a new network apparatus 2 is to be connected to the home network A of the user 1. Without additional information or pre-configuration, the apparatus 2 cannot decide whether it has a connection with the “right” network A or the “wrong” network B.

To solve this assignment problem in a simple and user-friendly way, the apparatus 2 is provided with a biometry module 3 and a configuration module 4. The biometry module 3 is adapted to detect biometrical data of a user 1. These biometrical data may be, for example, the fingerprint, speech, the shape of the ear or the hand, DNA traces, a handprint, a speed and print-differentiated signature or the like, for which suitable known sensors for detecting said values are known in the art. The biometry module 3 should satisfy given security standards so as to preclude the possibility of using, for example, biometrical data and their storage for purposes other than those desired. The biometry module 3 should be certified, for example, by an independent authority and sealed so as to prevent manipulation. Furthermore, the integrity of the biometry module 3 should be monitored and suitable for inspection by other units in the network.

The detected biometrical data are supplied to the configuration module 4 which derives a network identifier therefrom and preferably also a configuration key, which values may be subsequently used for eliminating the assignment problem as well as for a secure configuration procedure. The only condition is that the user 1 has supplied or now supplies his biometrical data at the (previous) configuration of the apparatuses of the network A which can establish a wireless communication connection (for example, points of access to cable connections with other apparatuses). The apparatuses of the network A are thus preferably implemented similarly as the apparatus 2.

Since the user 1 has access to his home network A as well as to the apparatus 2 to be connected but not to the home network B, the assignment problem can be solved by using the network identifier derived from his biometrical data. This means that, in a wireless communication via an interface 5, the configuration module 4 can detect whether it communicates with the “right” network A belonging to the user 1.

When managing the key based on the biometrical data, a simple, unintentional or unauthorized overwriting of a deposited key should be prevented. This can be achieved, for example, in that, for inputting new biometrical data (for example, other fingerprints of a user 1, fingerprints of other family members, guests or unauthorized persons), a second or repeated new input is required after a defined period of time after the first input (for example, one hour or one day), for which only the authorized user 1 knows the correct time intervals. The new input of biometrical data and the replacement of the existing key may also necessitate the input of the original biometrical data for the purpose of confirmation.

Furthermore, it is to be taken into account that the information based on the biometrical data of the user 1, including the biometrical data itself, should be erasable in order that the user 1 of the apparatus 2 can discard or sell the apparatus without giving away his personal data. Since the biometrical data are only necessary during the phase of initializing a secure autoconfiguration for eliminating the assignment problem as well as for establishing a data communication which is free from interception, they are preferably eliminated immediately after their use. Only the key data packets derived therefrom and network information are stored permanently. When the user 1 wants to introduce a new apparatus into the existing network at a later point of time, he will enter his biometrical data into the new apparatus whereupon the configuration module derives the unambiguous network identifier and/or the unambiguous initial key.

In this case, it is not necessary to use the initial key permanently. Instead, it is possible to use the initial key only for issuing further cryptography keys. This means that the initial key based on the biometrical data is used only for protecting a subsequent exchange of keys while all further communication is protected by the new (session) key.

Furthermore access to the configuration functions of the network can be arranged for a plurality of users (for example, family members). To this end, a list of biometrical data or values derived therefrom, for example, network identifiers is available for the authorized users of said group. In a phase of initialization, a number of admissible fingerprints (as an example of biometrical data) are presented to one or more apparatuses of the network A. A corresponding list of derived data is then generated from these fingerprints. Whenever a new apparatus 2 is to be introduced into the network A at a later point of time, it is sufficient for the acceptance of the new apparatus to provide it with one of the authorized fingerprints. The shared secret used for the network communication is then derived only indirectly, for example, from a primary fingerprint (which may be, for example, the first fingerprint presented to the network). Furthermore, different priorities may be defined among the various users and their corresponding biometrical data.

List of Reference Signs

A, B home networks
1 user
2 network apparatus
3 biometry module
4 configuration module
5 wireless interface

1. A network apparatus (2) comprising
a biometry module (3) for detecting biometrical data of a user (1);
a configuration module (4) which is adapted to determine an unambiguous network identifier and/or an unambiguous initial key from biometrical data provided by the biometry module (3) for the encrypted communication (particularly in the configuration phase) with a second apparatus.

2. An apparatus as claimed in claim 1, characterized in that it is adapted to eliminate the biometrical data of a user (1) after their use by the configuration module (4).

3. An apparatus as claimed in claim 1, characterized in that the communication with the second apparatus takes place in a wireless or wired way, particularly via a power supply mains.

4. An apparatus as claimed in claim 1, characterized in that the configuration module is adapted to manage a list of biometrical data and/or data derived from said list for different users (1) of an authorized user group.

5. A method of assigning a network apparatus (2) to a network (A), wherein biometrical data of a user (1) are detected by the apparatus (2) and an unambiguous network identifier is derived therefrom, which identifier is used and known in the network (A) from previous and/or simultaneous inputs of the same biometrical data.

6. A method of configuring a communication connection between a network apparatus (2) and a network (A), wherein biometrical data of a user (1) are detected by the apparatus and an unambiguous initial key is derived therefrom, which initial key is known in the network (A) from previous and/or simultaneous inputs of the same biometrical data and is used for a secure communication (particularly in the configuration phase).
